(19) United States
(12) Patent Application Publication
(10) Pub. No.: US 2013/0122151 A1
(43) Pub. Date: May 16, 2013

(54) Process for Spray Drying Botanical Food

(71) Applicants: Reza Ghaedian, Plymouth, MA (US); Rahul M. Shinde, New Bedford, MA (US); Nilesh Karava, Atlanta, GA (US)

(72) Inventors: Reza Ghaedian, Plymouth, MA (US); Rahul M. Shinde, New Bedford, MA (US); Nilesh Karava, Atlanta, GA (US)

(73) Assignee: DECAS BOTANICAL SYNERGIES, LLC, Carver, MA (US)

(21) Appl. No.: 13/483,799

(22) Filed: May 30, 2012

Related U.S. Application Data
(60) Provisional application No. 61/560,467, filed on Nov. 16, 2011.

(51) Int. Cl. A23P 1/06; A23L 1/36; A23L 1/212

(52) U.S. Cl. 426/71; 426/464; 426/640; 426/629; 426/93; 426/96

(57) ABSTRACT

In some embodiments, the invention provides processes for making a spray-dried whole botanical food powder from a whole botanical food. The processes comprise combining 0-95% of a juice component and 5-100% of at least one non-juice component of a whole botanical food to create a whole botanical food slurry, the at least one non-juice component comprising 0-100% intact botanical food, 0-100% skin, 0-100% pomace, and 0-100% seed or seed fiber, wherein the juice and non-juice components total 100%; adding water to the whole botanical food slurry to produce a mixture with a solids content of about 1-50%; heating the mixture to reduce viscosity and improve flow properties; shearing the mixture to create a uniform slurry; and spray drying the uniform slurry to form a spray-dried whole botanical food product. Also provided are powderized compositions made, for example, using the disclosed processes.

### CROSS REFERENCE TO RELATED APPLICATION

This application claims priority to U.S. Provisional Application Ser. No. 61/560,467 filed Nov. 16, 2011 the entire contents of which are hereby incorporated by reference.

### BACKGROUND OF THE INVENTION

The invention relates to the field of preparation of food, particularly the preparation of botanical powderized food.

There is a growing awareness by the public of the health benefits provided by botanical food. However, it is often difficult to get fresh produce depending upon the geographical location or season. Thus, there have been many efforts to preserve botanical food.

One such method for preserving botanical foods is by powderizing the food. Powderized food can be stored for lengthy amounts of time, and takes up much less space than canned food.

There are several different botanical (i.e., plant-based) powders available in the market, made using different processes. The most common powder is a standard juice powder, made using clarified, depectinized, juice from concentrates. These concentrates are free from suspended solids, thereby removing some of the nutritional value of the food. Moreover, it is difficult to dry a concentrate without adding some carrier such as magnesium hydroxide, maltodextrin or starch, etc., to the food, thereby diluting the nutritional value of the food and/or affecting taste. Further, to increase flowability of the concentrate (and thereby facilitate drying), a flow agent (e.g., tri-calcium phosphate, silicon dioxide etc.) is typically added to the food, thereby further diluting the health benefits and possibly affecting the flavor of the powderized food. Because these dried powders are hygroscopic in nature, their storage requirements are somewhat arduous—the powders must be stored in an air tight container with desiccant bags to avoid clumping from absorption of atmospheric moisture.

Other popular powders available in the market are the whole botanical powders with 100% solids. Drum drying, refractance window drying, freeze drying and rotary drum drying are commonly used for making whole fruit powders. However, there are several limitations of using these technologies.

The drum drying process to make food powder dries material on the surface of an internally heated revolving drum. The product to be dried is usually in fluid form, with solids either in solution or suspension (juice or puree). The material is applied as a thin layer to the outer surface of heated drums. The drying of material involves three changes of stages. First, the fluid temperature is raised to boiling point of the solution and continues to increase with increase in the concentration of solute. During second stage, there is a gradual change from liquid state to solid state, with constant increase in temperature. Finally the material is in solid state, where the temperature of the product reaches to that of heating drums. The dried material is scrapped off from the drum for further processing as per application (Tang J. et al., “Drum Drying”, pp. 211-214 in Encyclopedia of Agricultural, Food, and Biological Engineering, Marcel Dekker, Inc., New York, N.Y., 2003; and Van Marle D. J. Ind and Engg. Chemistry 30(9): 1006-1008).

Drum drying is energy efficient; however, long exposure time of the food to high temperatures can damage the nutritional content and/or flavor of the food. Additionally, drum drying results in uneven particle size of dried product, such that the resulting product requires further processing such as milling, sifting etc., prior to its use (Mujumdar S, Handbook of Industrial Drying, 2007).

Thus, while drum drying is useful for producing whole botanical powder, it cannot be used to produce juice powders, as it contains large amount of sugar which makes it difficult to scrape the powder from the drum surface. Further, as mentioned above, since juice powder is hygroscopic, juice powder produced by drum drying creates clumps which require further processing of the powder. Finally, drum drying, while energy efficient, is not capable of producing high volumes of powder in a short amount of time. (Tang J. et al., supra).

Another method for producing food powder is refractance window drying. Refractance window drying is fairly new development in drying technology and it falls under indirect or film drying technique. This process utilizes circulating hot water at 95-99° C. as a means to remove solvent from the material to be dehydrated. The wet material is spread as a thin layer on a moving plastic film, which moves over circulating hot water. This results in a very rapid drying. The film containing the dry product is then moved over circulating cold water to reduce the product temperature. The dry product is then scrapped off from the film using a blade and conveyed for further processing based on the desired finish product characteristics (Abonyi B. I. et al., J. Food Sci. 67(2): 1051-1056, 2001; Nindo C. I. et al., Drying Technology 25:37-48, 2007).

Advantages of refractance window drying include short residence time resulting in better color, flavor and nutrient retention of the powderized food (Abonyi B. I. et al., supra). Further, the heat transfer medium does not make direct contact with the product minimizing the risk of contamination. The temperature used to dry the product is much lower as compared to many other dehydration technologies available, and the unused heat from hot water is recycled to minimize energy losses. However, use of refractance window drying to produce food powder has several disadvantages. For example, further process is required after dehydrating food using the refractance window drying process. Additionally, the refractance window drying process is not suitable for standard juice powder, because the high sugar content in juices making it difficult to scrape the powder from the film surface as the sugar makes the powder very hygroscopic in nature (Nindo C. I. et al., supra). And, similar to the drum drying process, the refractance window drying process is not capable of producing high volumes of powder in a short amount of time.

Freeze drying of biological materials is one of the most suitable methods of water removal, which results in the highest quality powderized food product. The freeze drying or lyophilization process involves crystallization of suspension or liquids at freezing temperatures and then sublimation directly to the vapor phase under vacuum. The main goal of using freeze drying operation is to retain heat sensitive compounds in dried products. (Claussen I. C. et al., Drying Technology 25: 957-967, 2007; Sagar and Kumar, J. Food. Sci. Tech. 47(1): 15-26, 2010).

The most significant advantage of freeze drying is very high quality dry product, with all (or most) nutritional characteristics retained in the finished product. Another advantage of freeze drying is better retention of pore size and less shrinkage as compared to other drying methods. Also, the finished product made using freeze drying has better sensory and flavor qualities than products made with other drying methods (Sagar and Kumar, supra).

However, the main disadvantage of freeze drying is the high capital investment and operational costs. Freeze drying needs to be done under vacuum, which requires yet additional equipment and further contributes to the overall cost of using this process. Another disadvantage of freeze drying is the longer drying time as compared to other drying processes. Lastly, the finished product requires further processing like milling, sifting etc. (Claussen I. C. et al., supra).

Rotary drum drying is another method of drying available in the industry. Rotary dryer consist of big cylindrical shell (drum), heated using hot air or gas combustion chamber, through which the product moves. The drum speed can be adjusted to remove desired amount of water from raw material. Advantages of rotary drying are quick delivery of dried product, low maintenance cost and suitability of the process for high volumes. However, rotary drum dryers are less effective heat transferers, and thus require significantly large amount of energy to use. This lack of efficiency also requires a longer exposure of the food high heat, thereby possibly compromising nutritional content and/or flavor of the dried food. In addition, rotary drum dryers are unable to handle liquid slurries/juices (Fagernas L. et al., Biomass and Bioenergy 34: 1267-1277, 2010). Thus, rotary drum dryers cannot be used for standard juice powder. Further, rotary drum drying cannot handle fruit purees and so it this drying operation is not used for making whole botanical powder. Drying fresh fruit by rotary drum dryer to make whole fruit powder by further processing can be performed, but a significantly high amount of energy is required to remove water from fresh fruit. Also, the product color and quality are significantly lower as compared to other drying methods. This makes rotary drum drying the least preferred industrial operation for this drying fresh fruit (Tarhan S. et al., Indus Crops and Prod. 32:420-427, 2010).

Thus, while there are several different processes that are used to manufacture dried powders based on their physical and chemical properties, it would be useful to have a process for quickly and efficiently drying any kind of botanical food, regardless of its clarity and/or its insoluble material content.

### SUMMARY OF THE INVENTION

The invention provides a process for drying botanical food, regardless of its clarity and/or its insoluble material content.

Accordingly, in a first aspect, the invention provides a process for making a spray-dried whole botanical food product from a whole botanical food, the process comprising: combining 0-95% of a juice component and 5-100% of at least one non-juice component of a whole botanical food to create a whole botanical food slurry, the at least one non-juice component comprising 0-100% intact botanical food, 0-100% skin, 0-100% pomace, and 0-100% seed or seed fiber, wherein the juice and non-juice components total 100%; adding water to the whole botanical food slurry to produce a mixture comprising a suspended solids content of about 1-50%; heating the mixture to reduce viscosity and improve flow properties; shearing the heated mixture to reduce particle size and to create a uniform slurry; and spray drying the uniform slurry with a spray dryer to form a spray-dried whole botanical food product.

In some embodiments, the process comprises combining 0-95% of a juice component and 5-100% of at least one non-juice component of a whole botanical food to create a whole botanical food slurry, the at least one non-juice component comprising 0-100% intact botanical food, 0-100% skin, 0-100% pomace, and 0-100% seed or seed fiber, wherein the juice and non-juice components total 100% adding water to the whole botanical food slurry to produce a mixture with a solids content of about 1-20%; heating the mixture to a temperature between approximately 80 and 200 degrees Fahrenheit; shearing the mixture with a high shear mixer for 10 to 90 minutes to create a uniform slurry; pumping the uniform slurry through a high intensity shear pump to achieve a uniform particle slurry; atomizing the uniform particle slurry; and spray drying the uniform particle slurry to form a spray-dried whole botanical food product.

In some embodiments, the non-juice components of the whole botanical food components comprise 0-80% intact botanical food, 0-75% skin, 20-80% pomace, and 0-75% seed fiber. In some embodiments, the non-juice components of the whole botanical food components comprise 40-80% intact botanical food, 0% skin, 20-50% pomace, and 0-20% seed fiber. In some embodiments, water is added to the whole botanical food slurry to achieve a solids content of about 6-12%.

In some embodiments, the process further comprises cooling the spray-dried whole botanical food product in a cyclone. In some embodiments, the high shear mixer comprises a high shear impeller serrated blade. In some embodiments, the mixture is heated to 90-120 degrees Fahrenheit and sheared for 20-40 minutes.

In some embodiments, the high intensity shear pump has 1, 2 or 3 sets of tooth rotors/stators, and wherein the tooth rotors/stators are used at a tip speed of 1,800 to 10,000 rpm.

In some embodiments, the high intensity shear pump has 3 sets of tooth rotors/stators, and wherein the 3 sets of tooth rotors/stators are used at a tip speed of 1,000 to 3,000 rpm. In some embodiments, the high intensity shear pump is operated under a back pressure of 30-120 psi. In some embodiments, the high intensity shear pump achieves a highly uniform particle size distribution, wherein approximately 80% of the uniform particle slurry passes through a 30 mesh. In some embodiments, the high intensity shear pump is operated under a back pressure of 50-100 psi.

In some embodiments, atomizing the uniform particle slurry comprises the use of nozzle or spindle. In some embodiments, wherein a spindle is used, the spindle has a diameter of 4-12 inches. In some embodiments, wherein a spindle is used, the spindle is used at a spindle speed of 5,000 to 20,000 revolutions per minute. In some embodiments, wherein a spindle is used, the spindle has a diameter of 7-10 inches. In some embodiments, wherein a spindle is used, the spindle is used at a spindle speed of 15,000 to 18,000 revolutions per minute.

In some embodiments, spray drying the uniform particle slurry to form a spray dried whole botanical food product comprises using a spray dryer with a height to diameter ratio of 1.0 or less. In some embodiments, the spray drying comprises using a spray dryer that uses a co-current airflow pattern. In some embodiments, the spray drying comprises using a spray dryer comprising an inlet air temperature of 335-550 degrees Fahrenheit and an outlet air temperature of 160-280 degrees Fahrenheit. In some embodiments, the spray drying comprises using a spray dryer comprises an inlet air temperature of 400-450 degrees Fahrenheit and an outlet air temperature of 220-260 degrees Fahrenheit.

In some embodiments, the process further comprises milling the spray-dried whole botanical food product. In some embodiments, milling comprises using a hammer mill with a round perforated screen.

In some embodiments, the whole botanical food a vegetable, a herb, a fungi, a legume, or a fruit. In some embodiments, the whole botanical fruit is from the genus Vaccinium. In some embodiments, the whole botanical fruit is blueberries or cranberries.

In a further aspect, the invention provides a whole botanical food powder composition made using a process of the invention.

In another aspect, the invention provides a whole botanical food powder composition produced by spray-drying a starting composition comprising 0-95% of a juice component of a whole botanical food and 5-100% of at least one non-juice component of the whole botanical food, the at least one non-juice component comprising 0-100% pomace, 0-100% skin, 0-100% seed or seed fiber and 0-100% intact botanical food, wherein the juice and non-juice components total 100% in the starting composition and wherein the whole botanical food powder composition is characterized by a uniform particle size distribution and is non-hygroscopic.

In another aspect, the invention provides a whole botanical food powder composition produced by spray-drying a starting composition comprising 0-95% of a juice component of a whole botanical food and 5-100% of at least one non-juice component of the whole botanical food, the at least one non-juice component comprising 0-100% pomace, 0-100% skin, 0-100% seed or seed fiber and 0-100% intact botanical food, wherein the juice and non-juice components total 100% in the starting composition and wherein the whole botanical food powder composition is characterized by a uniform particle size distribution and is non-hygroscopic.

In yet another aspect, the invention provides a whole botanical food powder composition produced by spray-drying a starting composition comprising 0-95% of a juice component of a whole botanical food and 5-100% of at least one non-juice component of the whole botanical food, the at least one non-juice component comprising 0-100% pomace, 0-100% skin, 0-100% seed or seed fiber and 0-100% intact botanical food, wherein the juice and non-juice components total 100% in the starting composition and wherein the whole botanical food powder composition is characterized by a uniform particle size distribution and a water activity of 0.2 or less.

In some embodiments, the composition comprises non-juice components in amounts of 5-50% pomace, 0-90% skin, and 0-75% seed fiber and 0-90% intact botanical food.

In various embodiments, the botanical food is a vegetable, an herb, a fungi, a legume, or a fruit. In some embodiments, the botanical food is a fruit. In some embodiments, the fruit is from the genus Vaccinium. In some embodiments, the whole botanical fruit is a blueberry. In some embodiments, the whole botanical fruit is a cranberry.

In various embodiments, the fruit is from the genus Vitis. In some embodiments, the whole botanical fruit is a grape.

In a further embodiment, the composition comprises about 60% cranberry skins, 38% cranberry pomace and 2% cranberry seed fiber, and wherein the composition is characterized by a bulk density of 0.40-0.60 g/ml and a moisture content of 3-5%, and wherein at least 90% of particles in the composition pass through a 60 mesh.

In a further embodiment, the composition comprises about 80% intact cranberries, 18% cranberry pomace and 2% cranberry seed fiber, and wherein the composition is characterized by a bulk density of 0.5-0.7 g/ml and a moisture content of less than 5%.

In another embodiment, the composition comprises about 60% cranberry skins, 38% cranberry pomace and 2% cranberry seed fiber, and wherein the composition is characterized by a bulk density of 0.4-0.6 g/ml and a water activity of less than 0.2, and wherein at least 60% of particles in the composition pass through a 60 mesh.

In yet another embodiment, the composition comprises about 80% blueberry pomace and 20% blueberry pomace and wherein the composition is characterized by a bulk density of 0.4-0.6 g/ml and a moisture content of 3-5%.

In various embodiments of the invention, the composition is formulated into a capsule, a soft gel, or a tablet.

### BRIEF DESCRIPTION OF THE DRAWINGS

FIG. 1 is a schematic representation of a flow chart showing a non-limiting embodiment of the various methods of the invention.

FIGS. 2A-2G show a number of different spray dryer designs currently available. The designs depicted in FIGS. 2A-2G are not meant to limit the designs of the dryer that can be used in the various embodiments of the invention, as any spray dryer of any design can be readily employed.

### DETAILED DESCRIPTION OF THE PREFERRED EMBODIMENTS

Making whole fruit powders is focused mainly on the use of drum drying (Mann D. et al., U.S. Pat. No. 6,231,866) and more recently on refractance window drying (Bolland, et. al. U.S. Pat. No. 6,047,484). Due to the low throughput of processes like drum drying, refractance window drying etc. for whole botanical powders, however, a high throughput process would be highly desirable for commercially preparing such powders and dry food.

The present invention stems from the development of methods to dry and/or powderize whole botanical food using the high-through put spray drying technique.

The published patents, patent applications, websites, company names, and scientific literature referred to herein establish the knowledge that is available to those with skill in the art and are hereby incorporated by reference in their entirety to the same extent as if each was specifically and individually indicated to be incorporated by reference. Any conflict between any reference cited herein and the specific teachings of this specification shall be resolved in favor of the latter.

Spray drying is a known high throughput method that is useful for drying liquid botanical food. Spray drying involves transformation of food from fluid state to dried particulate form by spraying the fluid into a hot chamber (Chiou D et al., J. Food Eng. 82: 84-91, 2007). Spray drying involves three phases. First, atomization of liquid by appropriate device. After atomization, fine droplets of feed material are exposed to a drying medium in a chamber. During the drying phase the solvent is vaporized, which results in dried particles. Lastly, the dried particles are separated from drying medium using a duct and carried over to cyclones, allowing the product to cool before packaging (Krzysztof C et al., J. Pharma Sci. 92(2):575, 2010).

Spray drying has many advantages. For example, it is a rapid drying method, and therefore allows high throughput production of dried/powderized food. Also, the finished product quality remains constant during the entire run. Other advantages include full automation, which allows to record number of variables simultaneously and involves less handling resulting in high quality product.

However, some draw backs to spray drying includes its use of very high temperature. This results in a lower overall thermal efficiency, as large amount of heated air is passed through the chamber without contacting a particle. Also, the overall equipment cost is very high as compared to other dryers (Mujumdar S, Handbook of Industrial Drying, 2007, Gohel M. et al., supra).

The more inconvenient disadvantage to the present use of spray drying, which disadvantage the present invention overcomes, is that currently spray drying methods cannot dry liquids containing high amounts of insoluble solids.

Currently, spray drying is ideal for making standard juice powder from concentrate, as the amount of water that needs to be evaporated is small making it an efficient operation. Prior to the invention described herein, concentrates used to make dried botanical foods and powders using spray drying did not contain suspended solids (e.g., did not contain seeds, fruit fibers, skin, pectin, etc.), as these solids clogged the spray nozzles or atomizer(s) of the spray dryer. Such a clogging event would be an expensive and time-consuming occurrence, resulting in equipment malfunction and product loss. Thus, prior to the present invention, spray drying was not considered as an option for making whole fruit powder, as it contains large amount of insoluble solids.

In some embodiments, the invention provides the a process for making spray-dried product from a whole botanical food. Surprisingly, this spray-dried product is non-hygroscopic and has a very low water activity. In some embodiments, the spray-dried product provides ingredients with prebiotic activity and thus the product is useful, for example, to be mixed with a probiotic-containing composition.

Accordingly, in a first aspect, the invention provides a process for making a spray-dried whole botanical food product, the process comprising: combining 0-95% of a juice component and 5-100% of at least one non-juice component of a whole botanical food to create a whole botanical food slurry, the at least one non-juice component comprising 0-100% intact botanical food, 0-100% skin, 0-100% pomace, and 0-100% seed or seed fiber, wherein the juice and non-juice components total 100%; adding water to the whole botanical food slurry to produce a mixture comprising a suspended solids content of about 1-50%; heating the mixture to reduce viscosity and improve flow properties; shearing the heated mixture to create a uniform slurry; pumping the uniform slurry through a high intensity shear pump to achieve a uniform particle slurry; and spray drying the uniform particle slurry to form a spray-dried whole botanical food product.

In some embodiments, the uniform slurry comprises a reduced particle size as compared to the heated mixture prior to shearing. In some embodiments, the uniform slurry has a consistent flow for feeding a spray dryer and avoids clogging the spray dryer.

In some embodiments, the non-juice components comprise 0-80% whole botanical food, 0-75% skin, 20-50% pomace, and 0-75% seed or seed fiber.

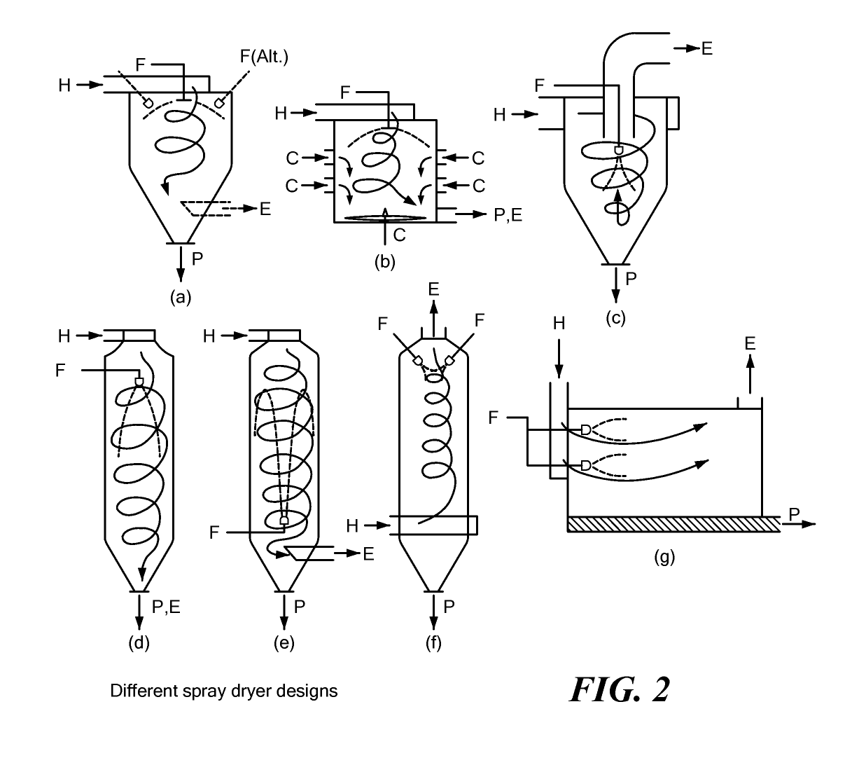

As used herein, by “spray drying” is meant a process for drying food that involves transforming the food from a fluid state to a dried particulate form by spraying the fluid and drying the sprayed fluid. In some embodiments, the spray drying comprises using a spray dryer comprising an inlet air temperature of 335-550 degrees Fahrenheit and an outlet air temperature of 160-280 degrees Fahrenheit. In some embodiments, the spray drying comprises using a spray dryer comprises an inlet air temperature of 400-450 degrees Fahrenheit and an outlet air temperature of 220-260 degrees Fahrenheit. A variety of apparatuses can be used for spray drying; FIGS. 2A-2G show a non-limiting number of different spray dryer apparatus designs. Food that has been prepared by spray drying may be referred to as “spray-dried” food.

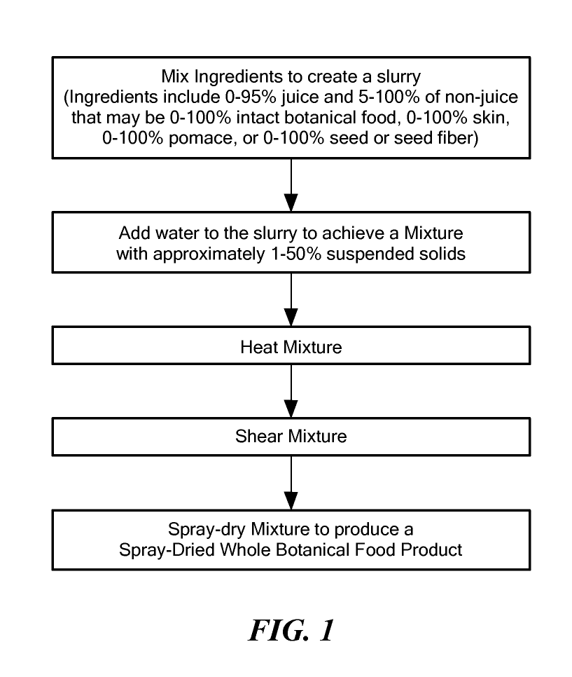

In accordance with various embodiments of the present invention, a process for making powder using any botanical components regardless of clarity and insoluble solids content by spray drying is provided. This process, a non-limiting embodiment of the invention, is schematically depicted in FIG. 1. As shown in FIG. 1, the ingredients of a whole botanical food (e.g., a fruit) are first mixed together to create a slurry. The slurry may contain some juice mixed with the non-juice components, or it may contain only non-juice components. Water is next added to the slurry to create a mixture comprising about 1-50% solids (e.g., the mixture may contain from 1-20% solids in suspension). These solids can be, for example, pieces of skin, pieces of seed, etc. The mixture can optionally be sheared at this point, and then heated. For example, the mixture can be heated to a temperature between approximately 80 and 200 degrees Fahrenheit. The heated mixture is then sheared (e.g., using a high shear mixture). For example, the heated mixture can be sheared for between about 10-90 minutes. The resulting sheared mixture can then optionally be forced through a screen (e.g., a 14 Mesh screen), and/or optionally passed through a magnet, and/or optionally passed through a high intensity shear pump to achieve a uniform particle slurry. Note that the various steps involving heating, shearing, passing through a magnet, and forcing through a screen are all optional, for the intended goal is to obtain a uniform slurry. Once a uniform slurry is achieved, the uniform slurry is spray dried using a spray dryer apparatus (also simply called a spray dryer) to achieve a spray-dried whole botanical food product

In some embodiments, the spray-dried whole botainical food product is non-hygroscopic. In other words, in some embodiments, the spray-dried whole botanical food product has a little to no ability to attract and hold water molecules from the surrounding environment. In some embodiments, the spray-dried whole botanical food product has less than 10% moisture, or has less than 8% moisture. In some embodiments, the spray-dried whole botanical food product has not more than 6% moisture. In some embodiments, the water activity of the spray-dried whole botanical food product is lower than 0.6, or is lower than 0.4. In some embodiments, the water activity of the spray-dried whole botanical food product is lower than 0.2. The spray-dried whole botanical food product can then optionally be passed through cyclones to cool, and then can optionally be further processed (milled using an auger and/or screen), and/or sifted to achieve the desired particle size for further application (e.g., packaging in capsules, soft gels, combining with probiotic-containing composition, etc.).

The processes of various embodiments of the invention have been achieved by designing a unique processing layout that employs a series of equipment to create a uniform particle size distribution without the use of any added carriers for spray drying into powders that are 100% natural. These powders made without the use of additives and carriers exhibit a wide range of characteristics for applications in soft gels, capsules, and tablets.

As used herein, by “botanical food” is meant, in its broadest use, any type of food that is not derived from an animal. Accordingly, the term includes, without limitation, fungi (e.g., truffles or mushrooms), vegetables (e.g., cucumber, broccoli, potatoes, cabbage, artichokes), herbs (e.g., basil, cilantro), spices (e.g., cinnamon, pepper), fruit (e.g., strawberries, blueberries, cranberries, apples, pears, tomatoes), and legumes (e.g., beans, peas, and lentils). In some embodiments, a botanical food does not include fruits or vegetables that cannot be consumed and digested by a human in their entirety. Thus, in some embodiments, a botanical food does not include pitted fruits and vegetables (e.g., cherries, peaches), fruits and vegetables with hard rinds or skins (e.g., pumpkins, bananas, and oranges).

“Food”, of course, is any substance consumed by any organism (e.g., human, reptile, amphibian, livestock animal, domesticated animal (e.g., a pet), bird, etc.) that provides some nutrition to that organism.

By the phrase “intact botanical food” is meant all the parts of the botanical food after it is harvested from the plant. Thus, an intact botanical food includes, without limitation, the intact botanical food (e.g., the intact fruit or vegetable including skin, seeds, core, etc.), the flesh of the botanical food (e.g., the flesh of the fruit or vegetables), the stem of the botanical food, the skin of the botanical food, core, the pomace of the botanical food, the juice of the botanical food, the seeds of the botanical food, and the seed fiber of the botanical food.

An intact botanical food has juice and non-juice components. As used herein, by “juice” is simply meant all the liquid that is produced by squeezing or pressing an intact botanical food. Non-juice components are simply other components of an intact botanical food that are not limited to juice. Accordingly, non-juice components include, without limitation, intact botanical food (which may include some juice), pomace, skin, stems, seeds, and seed fiber.

As used herein, by “pomace” is meant all parts of an intact botanical food after the juice of the food has been removed (e.g., by squeezing the botanical food or cold-pressing the food). Thus, pomace would include, among other things, skin and seeds. If the seeds, for example, are within a core (e.g., an apple), the pomace may also include the core. For example, all parts of a blueberry after juice is removed is called blueberry pomace. Pomace from a whole botanical food that is a fruit (e.g., a cranberry, a blueberry, or a grape) may also be referred to as “fruit fiber”.

In some embodiments, the seeds are pressed (e.g., cold-pressed) or squeezed to remove oil from the seeds prior to using the oil-reduced seeds (here called “seed fiber”) in the methods.

In particular embodiments, the invention relates to the use of the spray drying technique to dry and/or powderize berry fruits, such as blueberries or cranberries. In some embodiments, these powders can be formulated into capsule, tablets, or soft gels. In some embodiments, these powders have ingredients with prebiotic activity and can also be combined with probiotic-containing compositions.

Accordingly, in one non-limiting embodiment, the present invention relates to making a whole cranberry powder using various components of the cranberry plant (including the intact botanical food, skins and seeds). In further embodiments, the invention also provides the preparation of other dried and/or powderized botanical foods (e.g., vegetables, herbs, and other fruits) using the spray drying technique. The selection of the components and the proportions they are mixed in is a function of their chemical and physical properties. The unique process design described herein enables the creation of uniform slurry ready for spray drying while maintaining the efficacy and integrity of the original fruit components. Further, various embodiments of the invention allow selection of components in specific proportions and uses a unique combination of technologies to create high quality and consistent product. In particular embodiments, the invention pertains to using Vaccinium spp (i.e., a species of blueberry) and a series of size reduction equipment to create slurries without any added external carriers for spray drying into a 100% plant based powders.

Accordingly, in some embodiments, the invention provides a whole botanical powder (e.g., a spray-dried powder) produced using a unique combination of specific non-juice plant components. For example, the powder composition may comprise 0-95% of a juice component and 5-100% of at least one non-juice component, where the juice and non-juice components in the powder total 100%. In some embodiments, the non-juice component comprises intact botanical food (0-100%, such as 10-90%), skins (0-100%, such as 10-90%), pomace (0-100%, such as 5-50%) and/or seed or seed fiber (0-100%, such as 1-75%). In other words, any combination of the components may be used so long as the total equals 100% in the whole botanical food powder. In some embodiments, the powder comprises 100% non-juice components. For example, the powder may comprise 60% skin, 40% intact botanical food, 0% pomace, and 0% seeds or seed fiber (i.e., the total is 100%). In another non-limiting example, the powder may comprise 10% intact botanical food, 10% skin, 75% pomace, and 5% seeds or seed fiber. In accordance with various embodiments of the invention, these components are selected and mixed in these proportions based on their physical and chemical properties.

Plants store majority of the phytochemicals in the skins and seeds portion of the botanical food. These phytochemicals are highly bioactive in the human body and are associated with several health benefits. When preparing a liquid or slurry from a whole botanical food to powderize or dry, it is important to retain the skin and seeds in order to retain these phytochemicals. Additionally, other components in the botanical food such as skins and seeds are made up of pectin, lignans, cellulose, and other materials that affect product texture and viscosity are responsible for product movement and flowability. Hence, a right balance of these components is important for maximal health benefits of the food product as well as the process and final product characteristics.

In accordance with various embodiments of the invention, the components of the whole botanical food are mixed and sheared with water using a high intensity shear pump to create uniform particle size distribution. A technologically robust process is created to achieve a reduction in particle size variance. A large variance in the particle size distribution can lead to inconsistent product and an inefficient operation. Achieving a uniform distribution along with significant size reduction is critical to get the mixture ready for spray drying. As the material is sheared more and more of the parenchymal cell wall material is released into the medium leading to additional thickening. The material behaves as a non-Newtonian fluid where shear thickening is observed as more and more shear force is applied. The combination of the cell wall rupturing and release of components and the non-Newtonian behavior of the liquid needs to be controlled with the use of water and heat to manage viscosity and product flow. The sheared material having a small and uniform particle size distribution is then spray dried. A typical solids content of 1-20% is most suitable for shearing and spray drying.

The natural fibers present in the fruit act as inherent binding components aiding in providing the non-hygroscopic properties to the product. It should be noted that some attempts have been made to use dried finely ground fruit fiber (i.e., finely ground pomace) as an encapsulating agent during the spray drying of high potency botanical extracts to protect the phytochemicals. This is done to achieve a controlled release of phytochemicals in the body during digestion (Chiou et al., Drying Technology 25: 1423-1431, 2007). However, in some embodiments, the present invention involves no separation of the fiber from the rest of the whole botanical food but, rather, shearing the whole botanical food to achieve a uniform size reduction and distribution to enable spray drying.

The processing layout described herein is unique for its ability to create slurry that can be spray dried without using any carriers. As described herein, in some embodiments of the invention, the components of the processing layout were assembled with the intention of improving the physical properties of the botanical constituents being processed. To make these components or various blends of these components ready for spray drying, the material is sheared into fine, uniform particle sizes. In some embodiments, the key advantage of the processing layout is its ability to interchangeably use any plant component e.g. whole botanical food, skins, seeds, stems, or bark.

As discussed earlier, the general consensus is that spraying drying is more suitable for water soluble components in a solution format. This is because the solution can be easily pumped through the nozzle and atomizer set up to create fine particles required for spray drying. Insoluble materials however cannot be sprayed to create a dispersion required for uniform drying. Also, the insoluble components cannot dry quickly as soluble materials do. Final product is inconsistent and does not have uniform shape, particle size and moisture. Our invention is focused on the utilization of processing equipment that can shear the material into fine particles. This is achieved through significant modifications in operating parameters and set up styles. Through several such modifications, it was surprising found that components like seeds and fiber that are tough in nature and hard in texture were able to be sheared. This shearing provided a fine, consistent and uniform slurry that could be spray dried easily into fine consistent powder.

The product produced through this invention exhibits different physical behavior compared to typical juice powder. This may be due to the fact that there is a shear optimal limit to break the large tough insoluble particles. Rotap analysis of the powder for particle size distribution indicated that there are more large particles in this powder compared to typical juice powder (see Table 1). Note that typical juice powder is approx. 100% through an 80 Mesh and NLT (Not Less Than) 95% through a 100 Mesh.

TABLE 1
Particle size analysis of spray dried whole cranberry powder vs. standard spray
dried powder (i.e., powder from cranberry juice only, and not the whole fruit)

| Sample | Thru 20 Mesh | Thru 40 Mesh | Thru 60 Mesh | Thru 80 Mesh |
|---|---|---|---|---|
| Whole spray dried | 96.8% | 81.6% | 70.4% | — |
| cranberry powder | 96.0% | 84.0% | 77.2% | 74.0% |
| made using various | 81.6% | 51.2% | 41.2% | 38.0% |
| non-limiting | 80.4% | 51.2% | 41.6% | 38.8% |
| embodiments of the | 76.8% | 48.0% | 39.6% | 37.2% |
| present invention | 74.4% | 40.0% | 30.8% | 28.0% |
| | 73.2% | 41.6% | 34.4% | 32.4% |
| | 86.8% | 61.2% | 50.0% | 46.0% |
| | 80.8% | 49.6% | 39.2% | 35.6% |
| | 83.6% | 50.4% | 39.2% | 35.2% |
| | 80.0% | 48.8% | 39.2% | 35.2% |
| Standard spray | 100% | 100% | 100% | 100% |
| dried powder | | | | |

The product produced through various embodiments of the invention has different chemical composition as compared to standard juice powder. The nutritional data of spray dried cranberry powder compared to whole spray dried powder produced in accordance with a non-limiting embodiment of the invention is provided in Table 2.

TABLE 2
Nutritional data comparison of spray dried cranberry powder vs. whole spray dried powder.
NUTRITIONAL ANALYSIS
(per 100 grams)

| Standard juice powder (NutriCran 90) | | | Whole botanical powder (PACran) | | |
|---|---|---|---|---|---|
| Calories | 356 | KCal | Calories | 432 | KCal |
| Calories from Fat | 0.00 | KCal | Calories from Fat | 99 | KCal |
| Total Fat | 0.02 | g | Total Fat | 10.99 | g |
| Saturated Fat | 0.00 | g | Saturated Fat | 0.92 | g |
| Trans Fat | 0.00 | g | Trans Fat | 0.00 | g |
| Cholesterol | 0.00 | mg | Cholesterol | 0.0 | mg |
| Total Carbohydrates | 88.45 | g | Total Carbohydrates | 77.87 | g |
| Sugars | 37.91 | _g | Sugars | 13.21 | g |
| Dietary Fiber | 4.10 | g | Dietary Fiber | 45.90 | g |
| Protein | 0.46 | g | Protein | 5.38 | g |
| Moisture | 3.85 | g | Moisture | 4.60 | g |
| Ash | 7.22 | g | Ash | 1.11 | g |
| Vitamin A | 40 | IU | Vitamin A | 892 | IU |
| Vitamin C | 2.80 | m | Vitamin C | 19.4 | mg |
| Niacin | 1 | mg | Niacin | 0.75 | mg |
| Riboflavin | 0.41 | mg | Riboflavin | 0.7 | mg |
| Thiamin | 0.18 | mg | Thiamin | 0.24 | mg |
| Calcium | 118.3 | mg | Calcium | 60.4 | mg |
| Iron | 10 | mg | Iron | 6.61 | mg |
| Copper | 0.3 | mg | Copper | 0.40 | mg |
| Magnesium | 2757 | mg | Magnesium | 49.5 | mg |
| Phosphorus | 46.7 | mg | Phosphorus | 139.4 | mg |
| Potassium | 890 | mg | Potassium | 444.2 | mg |
| Sodium | 26.3 | mg | Sodium | 3.70 | mg |
| Zinc | 1.5 | mg | Zinc | 1.80 | mg |

As shown in Table 2, the typical dietary fiber content of standard juice powder is 3-7%. Comparatively the dietary fiber content of product made through one of the non-limiting methods of various embodiments of the invention has 40-80%. Also, typical juice powders contain 3-50% external carriers as against this the product made using one of the non-limiting methods of various embodiments of the invention does not require addition of external carriers.

Due to the hygroscopic and dusty nature of standard spray dried powder, it has several limitations for different applications. Also, it needs to be handled in a controlled environment during processing. Comparatively, the product made using current invention is not as hygroscopic in nature as standard juice powder and does not need controlled environment during processing.

In some embodiments of the invention, the dried or powderized whole botanical food comprises ingredients with prebiotic activity may be combined with probiotics-containing compositions to achieve heightened health benefits. As used herein, by an “ingredient having a prebiotic activity” (or simply a “prebiotic”) is meant a non-digestible food ingredient that can stimulate the growth and/or activity of bacteria in the digestive system of a multicellular organism (e.g., a human, a pet, an amphibian, a reptile, a domesticated animal, a bird, etc.). In some embodiments, the whole botanical food product produced by spray-drying is, for example, useful in combining with a probiotics-containing composition.

Accordingly, in another embodiment, the invention provides a composition comprising a whole botanical food powder and a probiotics-containing composition. Probiotics-containing compositions can be prepared according to standard methods (e.g., methods using those described herein) and are also commercially available from many sources (e.g., from Sedona Labs Pro, Garden of Life, iFlora, etc.). In some embodiments, the probiotics-containing composition comprises one or more bacteria from the following genuses: Lactobacillus (e.g., L. acidophilus), Leuconostoc, Pediococcus, Lactococcus (e.g., L lactis), and Streptococcus (e.g., S. thermophilus), and Bifidobacterium genus (e.g., B longum or B. dentium). See also Oelschlaeger T A., “Mechanisms of probiotic action—a review”, Int. J. Med. Microbiol. 300(1):57-62, 2010.

In some embodiments, the amount of prebiotic activity in a spray-dried whole botanical food product is adequate to promote the growth of the probiotic in a subject ingesting a probiotics-containing composition. By “adequate to promote the growth of the probiotic in a subject ingesting the probiotics-containing composition” is meant an amount of prebiotic (or a powder comprising an ingredient with prebiotic activity) that is sufficient to allow growth of the probiotic in a subject (e.g., a human subject) that has ingested the composition containing the probiotic. Of course, the subject may ingest the probiotic-containing composition by any means. For example, the probiotic-containing composition may be mixed with water to form a juice which can then be ingested by the subject, or may be formulated into, for example, a tablet, soft gel, or capsule for easy ingestion by the subject. In some embodiments, the spray-dried whole botanical food product comprising a prebiotic activity may be combined with any of these probiotic-containing compositions.

A combination of dried probiotics powder with standard spray dried powder (i.e., powder produced from liquid) is highly unstable and results in the loss of viability of the probiotics bacteria within two months of storage. Water activity (a_{w}) of a powder or substance is the amount of water in that powder or substance that is available to microorganisms. The high water activity of the standard (i.e., from liquid) spray dry powder, greater than 0.3, is responsible for this loss in viability. However, the spray-dried whole botanical food powder product of present invention has, in some embodiments, a water activity of less than 0.3. In some embodiments, the spray-dried whole botanical food powder product of the present invention has a water activity of less than 0.2. This low water activity prevents the loss in viability of the probiotics bacteria and extends their viability over 18 months of storage.

The particle size distribution and bulk density in standard spray dried juice powder is difficult to vary. A bulk density of 0.4 to 0.6 is desirable for capsules, while 0.5 to 0.7 is desirable for soft gels. The unique quality of the current invention is that the dried product can be further modified to achieve variable particle size and bulk density based on specific applications. The hygroscopic and dusty nature of standard spray dried juice powder poses several limitations in making capsules and sachets. Whole botanical food powder made using current invention is neither hygroscopic nor dusty in nature and can be easily delivered into a capsule or a sachet format.

In one non-limiting example, the following procedures can be used where the botanical food is fruit. Fruit components, namely whole fruit, juice, skins, fruit fiber (i.e., pomace) and/or seeds or seed fiber are mixed in various proportions in a tank with a high shear mixer. Sufficient amount of water is then added to the tank. The mixture is sheared to create a thin flowing slurry. The mixture can consist of intact fruit 10-90%, skins 10-90%, fruit fiber 5-50% and/or seed or seed fiber 1-75%. In some embodiments, the ratio is intact fruit 60-80%, fruit fiber 20-30% and seed or seed fiber 1-6%. Water is added to the mixture targeting specific solids content, ranging from 1-20%, for example, 6-12%. A high shear mixer is used to shear the material, preferably one with high shear impeller blade. The impeller blade can have various designs ranging from pick, high vane, poly peller, to high sear. Particularly, in this case a high shear impeller blade is used which has a serrated blade design that helps to disperse, cut, and shear the material all at the same time. The mixture is heated to 80 to 200° F., for 10 to 90 minutes, and sheared at the same time to create a uniform slurry. In this particular non-limiting example, the mixture is heated to 90-120° F. and sheared for 20-40 minutes.

Additional size reduction may be needed, in some embodiments, for the above mixture to create a uniform particle size for spray drying. This can be achieved by using a high intensity shear pump. The high intensity shear pump can have various designs based upon desired particle size and particle size distribution. A shear pump with 1, 2 or 3 sets of tooth rotors/stators and rotor tip speed of 1,800 to 10,000 rpm is used. Particularly in this case, a 3 stage rotors/stator with 1,000-3,000 rpm tip speed is used. The high intensity shear pump is operated under back pressure ranging from 30-120 psi to control the material entering the shearing zone. In this particular non-limiting example, the applied back pressure is 50-100 psi. A uniform particle size is achieved using this high intensity shear pump, where the particle size distribution is highly uniform with approximately 80% of the material passing through 30 mesh.

In some embodiments, the material is then atomized into a spray dryer. Atomization or dispersion is achieved using a nozzle or spindle set up, preferably in this case a spindle set up is used. Generally, the nozzles have a tendency to get clogged and need frequent cleaning. A spindle, on the other hand, can handle the fine insoluble solids with ease. The diameter and speed of the spindles determines the size of the particulates for drying. Spindle diameter can range from 4-12 inches. In some embodiments, the spindle with a diameter of 7-10 inches is used. Spindle speeds can range from 5,000 to 20,000 revolutions per minute (RPM). In some embodiments, the spindle speed is 15,000-18,000 RPM.

The atomized material is then passed through the spray drying chamber. Spray dryers can have various designs, which vary based on the height to diameter ratio, air flow patterns etc. In some embodiments, a height to diameter ratio can be 1.0 or less and 2.0 or more which affects the residence time, drying temperatures used etc. In some embodiments, a spray dryer with a height to diameter of 1.0 or less is used. Air flow patterns can also vary, see FIG. 2 and Table 3. Co-current, countercurrent and mixed air flows, each affect the drying temperature, residence time etc. In some embodiments, the air flow pattern is a co-current air flow. In some embodiments, the temperature of the air is critical to get consistent drying and achieve the moisture reduction. In some embodiments, inlet and outlet temperatures of the air used for drying can range from 350-550° F. for inlet and 160-280° F. for outlet temperatures. In some embodiments, due to the high insoluble solids content of the in-feed material, a higher inlet temperature of 400-450° F. and an outlet temperature of 220-260° F., can be used to obtain good, consistent dried product.

TABLE 3
Spray dryer designs and application. (Cook and DuMont, Chapter 4, Direct Dryers,
in Process Drying Practice, McGraw Hill Publication. p. 49-53, 1991).

| Spray Dryer | | | | |
|---|---|---|---|---|
| Design | Chamber Type | Airflow mode | Atomization type | Use |
| See FIG. 2A | Conical | Cocurrent | Disc or nozzle(s) | General, most widely used |
| See FIG. 2B | Cylindrical | Cocurrent | Disc | Heat sensitive products |
| See FIG. 2C | Cyclone | Mixed | Nozzle | Limited, high density products |
| See FIG. 2D | Tower | Cocurrent | Nozzle(s) | General |
| See FIG. 2E | Tower | Cocurrent | Nozzle | Low capacity; |
| | | | | inorganics, ceramics |
| See FIG. 2F | Tower | Countercurrent | Nozzle(s) | High density detergents |
| See FIG. 2G | Box | Cocurrent | Nozzle(s) | Dairy, food products |

The dried particles are then separated from the drying medium using a duct and carried over to cyclones. This allows the product to cool down and ready for further processing. Due to the high insoluble solids content of the dried product a higher air flow is needed to carry the material through the cyclones to avoid built up in the dryer.

As discussed above, the dried material has lower bulk density than typical spray dried powder. This provides an opportunity to process the powder and create products with desirable particle size and bulk density required for specific applications. The material can be milled using various mills, like hammer mill, air classifier mill, and/or pin mill. In this particular case a hammer mill is used. The mill uses retaining screens, viz. round perforated, herringbone slot, wedge wire and jump gap. In this particular case, the round perforated screen is preferred because it is structurally the strongest.

In a non-limiting embodiment, the present invention relates to using Vaccinium spp. and its components, with high percentage of insoluble materials, in specific proportions to create a product suitable for spray drying. An assembly of equipment in the sequence of mixing, shearing, high intensity shearing and spray drying with specific processing parameters is used to create a unique process to achieve the above product for the desired applications. These applications include but not limited to incorporation in capsule, soft gels and tablet forms for dietary supplements market.

Application A: Whole Cranberry Powder for Capsules

In this non-limiting application, to produce a powder from cranberries for use in capsules, a mixture of 38% cranberry fruit fiber (i.e., pomace which may contain some seed fiber and some skin fiber), an additional 60% cranberry skins, and an additional 2% cranberry seed fiber is added to the formulation tank equipped with a Cowles mixer having serrated blades. Water is then added to bring the solids content of the slurry to approximately 9% with continuous shearing and heating to 90° F. The mixture is sheared for 30 minutes and then passed through a 14 mesh filter. The mixture is further sheared using a high intensity quadro Y-tron z-emulsifier pump. The high intensity shear pump is operated using a three stage rotator and stator sets at 1,800 rpm with back pressure of 60-90 psi. The slurry is atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product may be processed, in some embodiments, using a micro-pulverizer hammer mill to target a particle size of minimum 90% through 60 mesh, a bulk density of 0.40-0.60 g/ml and a 1 1 moisture of 3-5%. This product is suitable for making different size capsules for the cranberry based dietary supplement market.

Application B: Whole Cranberry Powder for Soft Gel

In this non-limiting application, to produce a powder from whole cranberries for use in soft gels, a mixture of 80% whole cranberries, 18% cranberry fruit fiber (which may include some seed fiber) and an additional 2% cranberry seed fiber is added to the formulation tank equipped with a Cowles mixer having serrated blades. Water is then added to bring the solids content of the slurry to approximately 9% with continuous shearing and heating to target 90° F. The mixture is sheared for 30 minutes and then passed through a 14 mesh filter. The mixture is further sheared using a high intensity quadro Ytron z-emulsifier pump. The high intensity shear pump is operated using a three stage rotator and stator sets at 1,800 rpm with back pressure of 60-90 psi. The slurry is passed through the shear mixture twice. The slurry is then atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of 100% through an 80 mesh, a bulk density of 0.5-0.7 g/ml and a moisture of not more than (NMT) 5%. This product is suitable for making different size soft gels for the cranberry based dietary supplements market.

Application C: Whole Cranberry Powder for Probiotics

In this non-limiting application, to produce a powder from cranberries to be mixed with a probiotics-containing composition (e.g., freeze dried probiotics). For example, such a mixture can be encapsulated in capsules. In this non-limiting example, a mixture of 38% cranberry fruit fiber (which may include some skin and seed fiber), an additional 60% cranberry skins, and an additional 2% cranberry seed fiber is added to the formulation tank equipped with a Cowles mixer having serrated blades. Water is then added to bring the solids content of the slurry to approximately 9% with continuous shearing and heating to target 90° F. The mixture is sheared for 30 minutes and then passed through a 14 mesh filter. The mixture is further sheared using a high intensity quadro Ytron z-emulsifier pump. The high intensity shear pump is operated using a three stage rotator and stator sets at 1,800 rpm with back pressure of 60-90 psi. The slurry is passed through the shear mixture twice. The slurry is then atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of 60% through a 60 mesh, a bulk density of 0.4-0.6 g/ml and a water activity of less than 0.2. This product is suitable for combining with dried probiotics (e.g., in a ratio of 10-90% fruit fiber and 10-90% dried probiotics in a capsule for the cranberry based dietary supplements market. In some embodiments, the ratio may be 60% fruit fiber and 40% dried probiotics.

Application D: Whole Blueberry Powder for Capsules

In this non-limiting application, to produce a powder from whole blueberries for use in capsules, a mixture of 80% blueberries and 20% blueberry fruit fiber is added to the formulation tank equipped with a Cowles mixer having serrated blades. Water is then added to bring the solids content of the slurry to approximately 9-12% with continuous shearing and heating to 70° F. The mixture is sheared for 30 minutes and then passed through a 14 mesh filter. The mixture is further sheared using a high intensity quadro Y-tron z-emulsifier pump. The high intensity shear pump is operated using a three stage rotator and stator sets at 1,500 rpm with back pressure of 50-70 psi. The slurry is atomized using a 9″ spindle operated at 17,000 rpm. The atomized material is then passed through a spray drying chamber having a height to diameter ratio of 1.0 and concurrent air flow. The inlet temperature is set at 350-380° F. to achieve an outlet temperature of 170-190° F. The spray dried material is then passed through an air duct to separate the product from the drying medium and send to cyclones for cooling.

The dried product is processed using a micro-pulverizer hammer mill to target a particle size of minimum 80% through 60 mesh, a bulk density of 0.40-0.60 g/ml and a moisture of 3-5%. This product is suitable for making different size capsules for blueberry based dietary supplement market.

Application E: Whole Blueberry Powder for Soft Gel

In this non-limiting application, to produce a powder from whole blueberries for use in soft gels, a mixture of 60% whole blueberries and 40% blueberry fruit fiber (i.e., pomace including skin) is added to the formulation tank equipped with a Cowles mixer having serrated blades. Water is then added to bring the solids content of the slurry to approximately 9% with continuous shearing and heating to target 90° F. The mixture is sheared for 30 minutes and then passed through a 14 mesh filter. The mixture is further sheared using a high intensity quadro Ytron z-emulsifier pump. The high intensity shear pump is operated using a three stage rotator and stator sets at 1,800 rpm with back pressure of 60-90 psi. The slurry is passed through the shear mixture twice. The slurry is then atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of 100% through an 80 mesh, a bulk density of 0.5-0.7 g/ml and a moisture of not more than (NMT) 5%. This product is suitable for making different size soft gels for the blueberry based dietary supplements market.

Application F: Whole Blueberry Powder for Probiotics

In this non-limiting application, to produce a powder from blueberries to be mixed with a probiotics-containing composition (e.g., freeze dried probiotics). For example, such a mixture can be encapsulated in capsules. In this non-limiting example, 100% blueberry fruit fiber is added to the formulation tank equipped with a Cowles mixer having serrated blades. Water is then added to bring the solids content of the slurry to approximately 9% with continuous shearing and heating to target 90° F. The mixture is sheared for 30 minutes and then passed through a 14 mesh filter. The mixture is further sheared using a high intensity quadro Ytron z-emulsifier pump. The high intensity shear pump is operated using a three stage rotator and stator sets at 1,800 rpm with back pressure of 60-90 psi. The slurry is passed through the shear mixture twice. The slurry is then atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of 60% through a 60 mesh, a bulk density of 0.4-0.6 g/ml and a water activity of less than 0.2. This product is suitable for combining with dried probiotics (e.g., in a ratio of 10-90% fruit fiber and 10-90% dried probiotics in a capsule for the blueberry based dietary supplements market. In some embodiments, the ratio may be 60% fruit fiber and 40% dried probiotics.

Application G: Whole Grape Powder for Capsules

In this non-limiting application, to produce a powder from whole grapes for use in capsules, a mixture of 60% whole grapes and 40% grape fruit fiber (i.e., pomace, which includes skin and seeds) is added to the formulation tank equipped with a Cowles mixer having serrated blades. Water is then added to bring the solids content of the slurry to approximately 9% with continuous shearing and heating to 90° F. The mixture is sheared for 30 minutes and then passed through a 14 mesh filter. The mixture is further sheared using a high intensity quadro Y-tron z-emulsifier pump. The high intensity shear pump is operated using a three stage rotator and stator sets at 1,800 rpm with back pressure of 60-90 psi. The slurry is atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product may be processed, in some embodiments, using a micro-pulverizer hammer mill to target a particle size of minimum 90% through 60 mesh, a bulk density of 0.40-0.60 g/ml and a moisture of 3-5%. This product is suitable for making different size capsules for the grape based dietary supplement market.

Application H: Whole Grape Powder for Soft Gel

In this non-limiting application, to produce a powder from whole grapes for use in soft gels, a mixture of 80% whole grapes, 18% grape fruit fiber (which may include some seed fiber) and an additional 2% grape seed fiber is added to the formulation tank equipped with a Cowles mixer having serrated blades. Water is then added to bring the solids content of the slurry to approximately 9% with continuous shearing and heating to target 90° F. The mixture is sheared for 30 minutes and then passed through a 14 mesh filter. The mixture is further sheared using a high intensity quadro Ytron z-emulsifier pump. The high intensity shear pump is operated using a three stage rotator and stator sets at 1,800 rpm with back pressure of 60-90 psi. The slurry is passed through the shear mixture twice. The slurry is then atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of 100% through an 80 mesh, a bulk density of 0.5-0.7 g/ml and a moisture of not more than (NMT) 5%. This product is suitable for making different size soft gels for the grape based dietary supplements market.

Application I: Whole Grape Powder for Probiotics

In this non-limiting application, to produce a powder from grapes to be mixed with a probiotics-containing composition (e.g., freeze dried probiotics). For example, such a mixture can be encapsulated in capsules. In this non-limiting example 100% grape fiber (i.e., pomace including skin and seeds) is added to the formulation tank equipped with a Cowles mixer having serrated blades. Water is then added to bring the solids content of the slurry to approximately 9% with continuous shearing and heating to target 90° F. The mixture is sheared for 30 minutes and then passed through a 14 mesh filter. The mixture is further sheared using a high intensity quadro Ytron z-emulsifier pump. The high intensity shear pump is operated using a three stage rotator and stator sets at 1,800 rpm with back pressure of 60-90 psi. The slurry is passed through the shear mixture twice. The slurry is then atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of 60% through a 60 mesh, a bulk density of 0.4-0.6 g/ml and a water activity of less than 0.2. This product is suitable for combining with dried probiotics (e.g., in a ratio of 10-90% fruit fiber and 10-90% dried probiotics in a capsule for the grape based dietary supplements market. In some embodiments, the ratio may be 60% fruit fiber and 40% dried probiotics.

Application J: Whole Sweet Potato Powder

Sweet potatoes are very rich in carotenoids, vitamins A, B6, C, potassium, iron and fiber. Much of their fiber comes from the flesh of the sweet potato, however a richer source is the sweet potato skin. Because of their high fiber content, sweet potatoes cannot be liquified and thus cannot be powderized using conventional spray drying methods. In this non-limiting example, to produce a powder from whole sweet potatoes using the methods of various embodiments of the invention, a mixture of 60% sweet potato skins and 40% sweet potato is added to the formulation tank equipped with a Cowles mixer having serrated blades. Water is then added to bring the solids content of the slurry to approximately 1-20% with continuous shearing and heating to 90° F. The mixture is sheared for 30 minutes and then passed through a 14 mesh filter. The mixture is further sheared using a high intensity quadro Y-tron z-emulsifier pump. The high intensity shear pump is operated using a three stage rotator and stator sets at 1,800 rpm with back pressure of 60-90 psi. The slurry is atomized using a 9″ spindle operated at 17,000 rpm. The atomized material is then passed through a spray drying chamber having a height to diameter ratio of 1.0 and concurrent air flow. The inlet temperature is set at 400-420° F. to achieve an outlet temperature of 220-230° F. The spray dried material is then passed through an air duct to separate the product from the drying medium and send to cyclones for cooling.

The dried product is processed using a micro-pulverizer hammer mill to target a particle size of minimum 90% through 60 mesh, and a moisture of 3-5%. This product is suitable for space efficient, long term storage (e.g., over two months or up to 18 months) and can be used to supplement diets of nutritionally challenged individuals (e.g., in third world countries) or reconstituted food for infants or the elderly.

The following Examples are provided only to further illustrate the various embodiments the invention, and are not intended to limit its scope, except as provided in the claims appended hereto. The various embodiments of the present invention encompasses modifications and variations of the methods taught herein which would be obvious to one of ordinary skill in the art. Materials, reagents and the like to which reference is made are obtainable from commercial sources, unless otherwise noted.

### Example 1

The first example was conducted using cranberry skins. Approximately 1,000 lbs of cranberry skins were added to a tank with a Cowles disperser along with approximately 1,000 lbs of water. The Cowles disperser was used with a high shear blade to shear the product while mixing it. At dispersion speeds of 4,000 to 6,000 RPM, the Cowles disperser provided high velocity and turbulence to the mixture. A rapid hydraulic attrition zone was created which utilized shear and impact energies to achieve size reduction. The mixture was allowed to shear for approx. 30 mins. Following which the mixture was pumped into the feed tank and spray dried using the proprietary spray dryer build by GEA Westfalia.

The spray dried powder consisted of particles that were large in size and high in moisture. Initial moistures were 14-16%. The inlet and outlet temperatures were increased to bring the moisture down to 5-6%. The demand on the energy was significantly high and feed rate had to be reduced to meet these moisture requirements. Along with inconsistent moisture, other issues observed were clumping, sogginess, and broad particle size distribution. Large pieces had more moisture than the smaller ones. The feed nozzle and atomizer system also clogged frequently, requiring that the dryer be stopped and cleaned.

### Example 2

The second example was conducted using cranberry skins and cranberry press cake (i.e., pomace). A target ratio of 3:1 was used. Approx. 2,000 pounds (lbs) of skins and approx. 1,500 lbs of water were mixed in a tank with Cowles disperser. After shearing the mixture for 10 mins cranberry pomace was added in increments to the same tank. Total pomace to be added was 666 lbs to provide a ratio of 3:1 for skins and pomace on wet basis. But after adding the first 200 lbs of pomace all the water in the system dried up and the mixture did not flow well. Shearing the mixture was not possible. Consequently, another 500 lbs of water was added. This helped to shear the mixture but again as soon as another 200 lbs of pomace was added the water dried up. Additional 200 lbs of water was added, the mixture sheared and then all the remaining pomace was added. Final solids content was tested on the slurry and identified to be approximately 12.6%. The mixture was very thick and difficult to shear. To thin out the mixture, water was added continuously to the mixture to see where the product becomes consistent and starts flowing well. When this was achieved the solids content was checked. This was approximately 7% solids. This was identified as a cut off solids content to get the product ready for shearing and spray drying based on the ease of handling. After this the mixture was allowed to shear for approx. 30 mins. using the Cowles disperser. After testing the material using a 30 Mesh screen it was identified that additional high speed shearing is required before the material can be spray dried. To help achieve this goal a reversible homogenizer, standard V series, 38-60 from Arde Barinco was used. The homogenizer was placed at the bottom of a tank. So, the Cowles dispenser was removed and replaced it with the Arde Barinco homgenizer. The homogenizer was first set in its mixing mode used to wet pretty much any product by creating a strong vortex pulling the product in from the center. The mixture was allowed to shear for approx. 30 mins and then an attempt was made to spray dry it. Similar issues arose. For example, the moisture coming out of the dryer was too high, 17% and 18% moisture. After reducing the now rates and increasing the temperatures, the amount of moisture coming out of the dryer was reduced to 4-6%. But still the particle sizes were too big, there was inconsistency in the material for moisture. This indicated that the slurry had to be significantly more sheared.

### Example 3

The starting material in this example was 1,200 pounds (lbs) of skins and 400 lbs of pomace, a 75:25 ratio for skins to pomace. The pomace was first introduced into the tank with the Cowles disperser. Next, 1,800 pounds of water was added and recorded, then the skins were added and the solid content checked. The solid content was found to be 12.7%. Following this, water was added water in increments of 400 lbs and checking the solids to understand how much water is needed. Finally, when the batch was ready the slurry was at 7.1% solids and sheared for 2 hours using the Arde Barinco reversible homogenizer.

The spray drying was then monitored based on previous settings to achieve 4-6% moisture. Based on the results the rate of drying was identified to be 80 lbs/hr which is almost 3 times slower than regular juice powder, which typically can be spray dried at 240 pounds/hour.

To improve the quality of the product, the product had to be sheared more. Additional equipment was next explored to determine which machines could perform this task.

### Example 4

For this test, all the steps from test 3 were repeated except for the introduction of a high intensity shear pump to shear the mixture to reduce and achieve uniform particle size distribution. The high intensity shear pump used was one made by Y-tron, called the Z-emulsifier. The equipment has a 3 set rotor/stator blade system which is designed to be operated with a back pressure of 10 120 psi. The mixture was run through this shear pump with a back pressure of 50-90 psi twice to achieve a uniform particle size distribution. The material passed 100% through a 20 Mesh. The material was then spray dried using a nozzle set up. The material dried very well and not less than (NLT) 6% moisture was achieved with a target outlet temperature of 220° F. The material was observed to have expanded during drying as it did not pass 100% through a 20 Mesh (see Table 1 above). Additional milling was required to meet the specifications for standard juice powder or whole fruit powder.

After 2 hours, the nozzles started clogging and atomizing the product was difficult. This implied that a nozzle set up was not the best type of set-up for spray drying this type of material.

### Example 5

Based on Example 4, the nozzle set up was replaced with a spindle set up to avoid clogging and achieve consistent atomization of the material throughout the test. The dried product was cooled using the cyclones and milled using a hammer mill with round screen. The hammer mill was initially cooled using nitrogen but this caused material flow issues and the nitrogen was replaced with ambient air for cooling during milling. This combination of equipment was found to provide the most consistent and desirable product for commercial applications.

### Examples 6 to 9

Example 5 was repeated multiple times using changed dryer inlet and outlet temperature settings to achieve optimal use of energy to dry the product during spray drying.

Based on these results, several formulations were finalized. One such formulation when wet had a percentage (by weight) of 0% whole (intact) fruit, 75% skin, 25% pomace, and 0% seed fiber. After drying the formulation, by weight the formulation had 0% whole (intact) fruit, 50% skins, 50% pomace, and 0% seed fiber.

Another formulation when wet had a percentage (by weight) of 80% whole (intact) fruit, 0% skin, 20% pomace, and 0% seed fiber. When this formulation was dry, by weight the formulation had 50% whole (intact) fruit, 0% skins, 50% pomace, and 0% seed fiber.

Yet another formulation when wet had a percentage (by weight) of 80% whole (intact) fruit, 0% skin, 20% pomace, and 0% seed fiber. When this formulation was dry, seed fiber was added so that by weight the dry formulation had 40% whole (intact) fruit, 0% skins, 40% pomace, and 20% seed fiber.

While the invention has been described with particular reference to the illustrated embodiments, it will be understood that numerous modifications thereto will appear to those skilled in the art. Accordingly, the above description, the following claims, and accompanying drawings should be taken as illustrative of the invention and not in a limiting sense.

1. A process for making a spray-dried food product from a whole botanical food, the process comprising:
combining 0-95% of a juice component and 5-100% of at least one non-juice component of a whole botanical food to create a whole botanical food slurry, the at least one non-juice component comprising 0-100% intact botanical food, 0-100% skin, 0-100% pomace, and 0-100% seed or seed fiber, wherein the juice and non-juice components total 100%;
adding water to the whole botanical food slurry to produce a mixture comprising a suspended solids content of about 1-50%;
heating the mixture to reduce viscosity and improve flow properties;
shearing the heated mixture to reduce particle size and to create a uniform slurry; and
spray drying the uniform slurry with a spray dryer to form a spray-dried whole botanical food product.

2. The process according to claim 1, wherein the mixture comprises a suspended solids contents of about 1-20%.

3. The process according to claim 1, wherein following the shearing step, the uniform slurry is further pumped through a high intensity shear pump prior to the spray drying step.

4. The process according to claim 1, wherein the uniform mixture has a consistent flow for feeding into the spray dryer and for preventing clogging of the spray dryer.

5. The process according to claim 1, wherein the non-juice components comprise 0-80% intact botanical food, 0-75% skin, 20-80% pomace, and 0-75% seed or seed fiber.

6. The process according to claim 1, further comprising cooling the spray-dried whole botanical food product in a cyclone.

7. The process according to claim 1 or 6, further comprising milling the spray-dried whole botanical food product.

8. The process according to claim 7, wherein milling comprises using a hammer mill with a round perforated screen.

9. The process according to claim 1, wherein the non-juice components comprise 0% skin, 20-50% pomace, and 0-20% seed or seed fiber.

10. The process according to claim 1, wherein water is added to the whole botanical food slurry to achieve a solids content of about 6-12%.

11. The process according to claim 1, wherein the high shear mixer comprises a high shear impeller serrated blade.

12. The process according to claim 1, wherein the mixture is heated to 90-120 degrees Fahrenheit and sheared for 20-40 minutes.

13. The process according to claim 3, wherein the high intensity shear pump has 1, 2 or 3 sets of tooth rotors/stators, and wherein the tooth rotors/stators are used at a tip speed of 1,800 to 10,000 rpm.

14. The process according to claim 3, wherein the high intensity shear pump has 3 sets of tooth rotors/stators, and wherein the 3 sets of tooth rotors/stators are used at a tip speed of 1,000 to 3,000 rpm.

15. The process according to claim 3, wherein the high intensity shear pump is operated under a back pressure of 30-120 psi.

16. The process according to claim 1, wherein the high intensity shear pump achieves a highly uniform particle size distribution, wherein approximately 80% of the uniform particle slurry passes through a 30 mesh.

17. The process according to claim 1, wherein the high intensity shear pump is operated under a back pressure of 50-100 psi.

18. The process according to claim 1, wherein atomizing the uniform particle slurry comprises the use of a nozzle or a spindle.

19. The process according to claim 18, wherein the spindle is used, and wherein the spindle has a diameter selected from the group consisting of 4-12 inches and 7-10 inches

20. The process according to claim 18, wherein the spindle is used, and wherein the spindle is used at a spindle speed selected from the group consisting of 5,000 to 20,000 revolutions per minute and 15,000 to 18,000 revolutions per minute.

21. The process according to claim 1, wherein the whole botanical food is selected from the group consisting of a vegetable, a herb, a fungi, a legume, and a fruit.

22. The process according to claim 21, wherein the fruit is from the genus Vaccinium.

23. The process according to claim 21, wherein the fruit is selected from a group consisting of blueberries and cranberries.

24. The whole botanical food powder composition made using the process according to any of claims 1-23.

25. A whole botanical food powder composition produced by spray-drying a starting composition comprising 0-95% of a juice component of a whole botanical food and 5-100% of at least one non-juice component of the whole botanical food, the at least one non-juice component comprising 0-100% pomace, 0-100% skin, 0-100% seed or seed fiber and 0-100% intact botanical food, wherein the juice and non-juice components total 100% in the starting composition and wherein the powder composition is characterized by a uniform particle size distribution and is non-hygroscopic.

26. A whole botanical food powder composition produced by spray-drying a starting composition comprising 0-95% of a juice component of a whole botanical food and 5-100% of at least one non-juice component of the whole botanical food, the at least one non-juice component comprising 0-100% pomace, 0-100% skin, 0-100% seed or seed fiber and 0-100% intact botanical food, wherein the juice and non-juice components total 100% in the starting composition and wherein the powder composition comprises a prebiotic activity.

27. A whole botanical food powder composition produced by spray-drying a starting composition comprising 0-95% of a juice component and 5-100% of at least one non-juice component of a whole botanical food, the at least one non-juice component comprising 0-100% pomace, 0-100% skin, 0-100% seed or seed fiber and 0-100% intact botanical food, wherein the juice and non-juice components total 100% in the starting composition and wherein the composition is characterized by a uniform particle size distribution and a water activity of 0.2 or less.

28. The composition according to claim 25, 26, or 27, wherein the composition comprises non-juice components in amounts of 5-50% pomace, 0-90% skin, 0-75% seed or seed fiber and 0-90% intact botanical food.

29. The composition according to claim 25, 26, or 27, wherein the botanical food is selected from the group consisting of a vegetable, an herb, a fungi, a legume, and a fruit.

30. The composition according to claim 25, 26, or 27, wherein the botanical food is a fruit.

31. The composition according to claim 30, wherein the fruit is from the genus Vaccinium.

32. The composition according to claim 30, wherein the fruit is selected from a group consisting of blueberry and cranberry.

33. The composition according to claim 30, wherein the fruit is cranberry and the composition comprises about 60% cranberry skins, 38% cranberry pomace and 2% cranberry seed or seed fiber, and wherein the composition is characterized by a bulk density of 0.40-0.60 g/ml and a moisture content of 3-5%, and wherein at least 90% of particles in the composition pass through a 60 mesh.

34. The composition according to claim 30, wherein the fruit is cranberry and the composition comprises about 80% intact cranberries, 18% cranberry pomace and 2% cranberry seed or seed fiber, and wherein the composition is characterized by a bulk density of 0.5-0.7 g/ml and a moisture content of less than 5%.

35. The composition according to claim 30, wherein the fruit is cranberry and the composition comprises about 60% cranberry skins, 38% cranberry pomace and 2% cranberry seed or seed fiber, and wherein the composition is characterized by a bulk density of 0.4-0.6 g/ml and a water activity of less than 0.2, and wherein at least 60% of particles in the composition pass through a 60 mesh.

36. The composition according to claim 30, wherein the fruit is blueberry and the composition comprises about 80% blueberry pomace and 20% blueberry pomace and wherein the composition is characterized by a bulk density of 0.4-0.6 g/ml and a moisture content of 3-5%.

37. The composition according to claim 30, wherein the fruit is from the genus Vitis.

38. The composition according to claim 30, wherein the fruit is a grape.

39. The composition according to claim 25, 26, or 27, wherein the composition is formulated into a capsule.

40. The composition according to claim 25, 26, or 27, wherein the composition is formulated into a soft gel.

41. The composition according to claim 25, 26, or 27, wherein the composition is formulated into a tablet.
